(19) United States
(12) Patent Application Publication
(10) Pub. No.: US 2005/0167521 A1
(43) Pub. Date: Aug. 4, 2005

(54) Scent delivery system using consuming apparatus

(76) Inventor: Jerome Glasser, Maplewood, NJ (US)

Correspondence Address: JEROME GLASSER, 16 Sunset Terrace, Maplewood, NJ, 07040, US

(21) Appl. No.: 10/771,247

(22) Filed: Feb. 3, 2004

(51) Int. Cl. A61J 15/00

(52) U.S. Cl. 239/34; 239/47; 239/33

(57) ABSTRACT

A scent delivery system provides for an enhanced consumption experience by providing for fragrance or scent close to the nose during the consumption process and includes, without limitation thereto, beverage cup, beverage cup cap, straw, bowl, plate, eating utensils such as knife, fork, spoon, spork, preferably of plastic or coated with plastic, and in such an instance in which an item is fabricated of plastic, the scent or fragrance may be integrally molded entirely throughout the plastic in order to offer a long-term release of scent, the control of which may be better influenced by the packaging of the elements of this system in vapor-barrier plastic which impedes the escape of scent until use of an entire system or elements thereof is desired.

### FIELD OF THE INVENTION

The present invention relates to a scent delivery system which, in a preferred embodiment takes the form of eating and/or drinking apparatus.

### BACKGROUND OF THE INVENTION

Prior art discloses numerous innovations in the field of air freshening as well as in the field of items facilitating the consumption of edible items. Even though these prior art innovations may be suitable for the specific, individual purposes which they address, they differ from the present invention.

Scientific research has determined that approximately 80-90% of what humans and animals perceive as “taste” may actually be attributed to the sense of smell. Moreover, recent technological advances in the plastics industry now permit the production of molded and extruded products with a scent or fragrance integrally molded either throughout a coating, or through the plastic of which many eating and drinking utensils are manufactured today. These processes characteristically afford a long-term release of a scent which gets impregnated in a plastic, and, moreover, can be accomplished relatively inexpensively. Heretofore, however, knowledge of scent's influence on taste has not been combined with the knowledge of the existence of the advanced capability of mixing a scent virtually entirely throughout an item either manufactured of plastic or made of another material coated by plastic.

Both at home and in restaurants, millions of people eat with plastic utensils on plastic plates and drink beverages through cups, cup lids and straws made of plastic. Animals, too eat and drink from plastic bowls and dishes. The eating and drinking experience can be dramatically affected by the combination of a utensil or multiple utensils with a scented plastic. The reason for this is that elements considered eating and drinking apparatus are very close to a drinker's nose during conventional use.

Accordingly, impregnating the plastic of a straw, for example, with a pleasant scent will, necessarily, enhance and improve the taste sensation that the drinker experiences, since science has determined the value and power of scent towards influencing the flavors that humans and animals perceive when eating and drinking.

There has never before been any product developed, nor has there been any prior art disclosed to suggest the invention of this disclosure.

### SUMMARY AND OBJECTS OF THE INVENTION

The present invention discloses a system including eating and drinking apparatus either made of plastic, or coated with a plastic coating in which a scent is mixed.

One of the objects of this invention is to provide an inexpensive means to affect the taste of food and liquid for human consumption, either improving, hurting or neutralizing its flavor via the addition of a scent to the instruments which are traditionally used to deliver food and drink to the mouth.

Another object of this invention is to provide a storage packaging means including a vapor-barrier plastic known to one skilled in the art, in order to better maintain the scent of the consuming utensil within the packaging until use is desired.

### BRIEF DESCRIPTION OF THE DRAWINGS

FIG. 1 discloses a frontal view a drinking apparatus emitting a scent;

FIG. 2 discloses a frontal view of a drinking apparatus enclosed within vapor barrier film packaging;

FIG. 3 discloses a side view of a cap with a straw therethrough, each of which has scent emanating therefrom;

FIG. 4 discloses a bird's eye view of a cap enclosed within vapor barrier film packaging;

FIG. 5 discloses a side view illustrating how cap, cup, and straw interact;

FIG. 6 discloses a cup which gives-off a scent;

FIG. 7 discloses traditional “Western” eating utensils which give-off a scent;

FIG. 8 discloses a “skewer” which gives-off a scent;

FIG. 9 discloses a plate which gives-off a scent;

FIG. 10. discloses typical chopsticks;

FIG. 11. discloses an object impregnated and/or coated with scent which is added to a consuming utensil such as a straw.

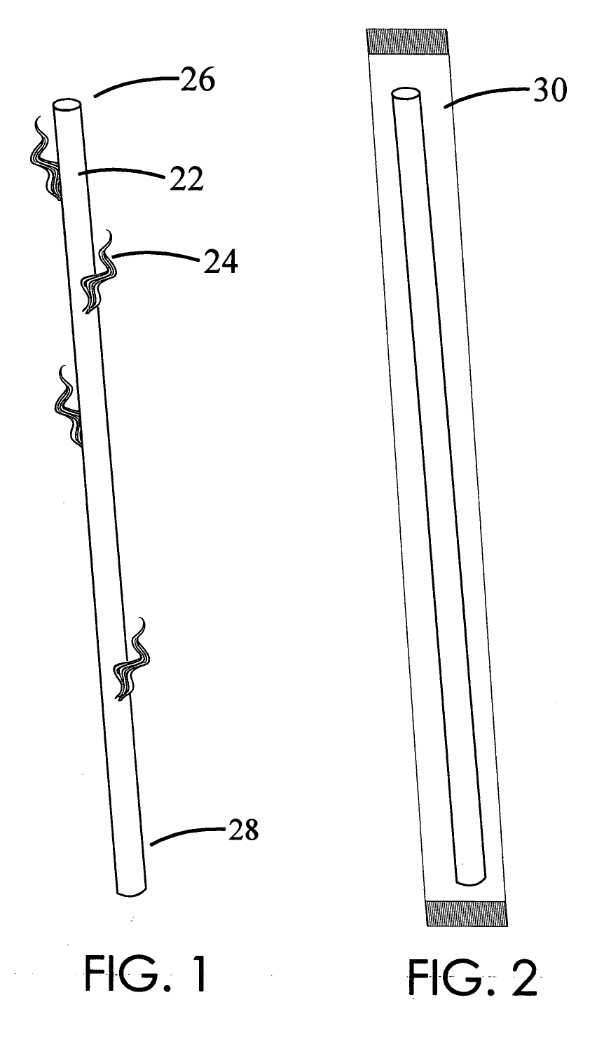

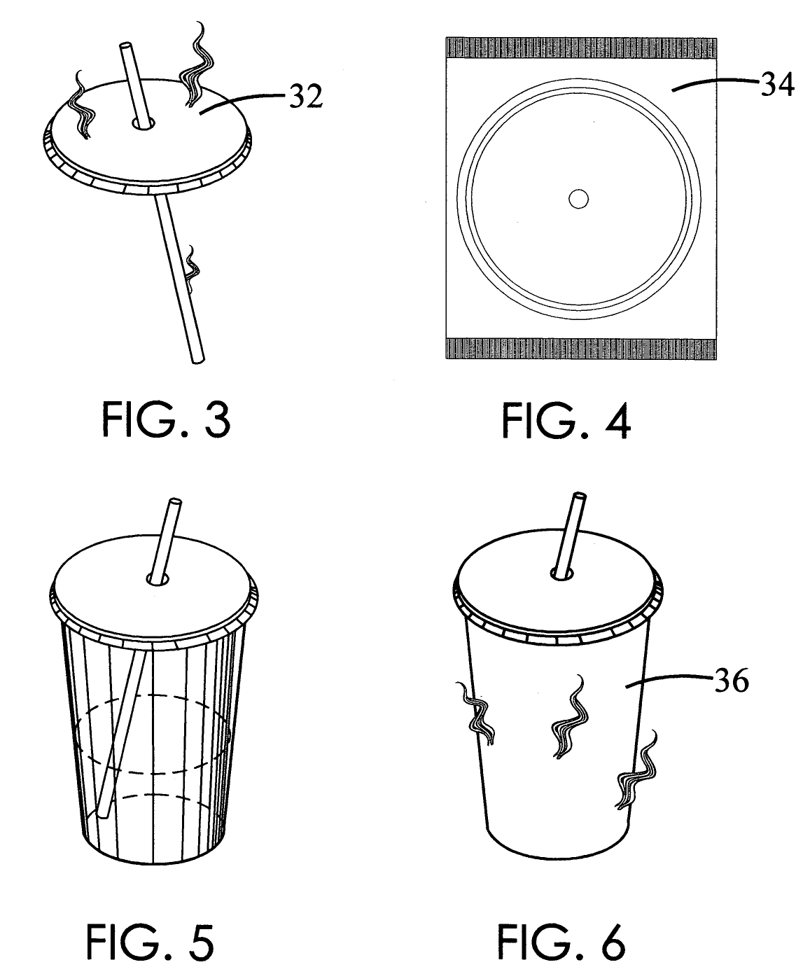

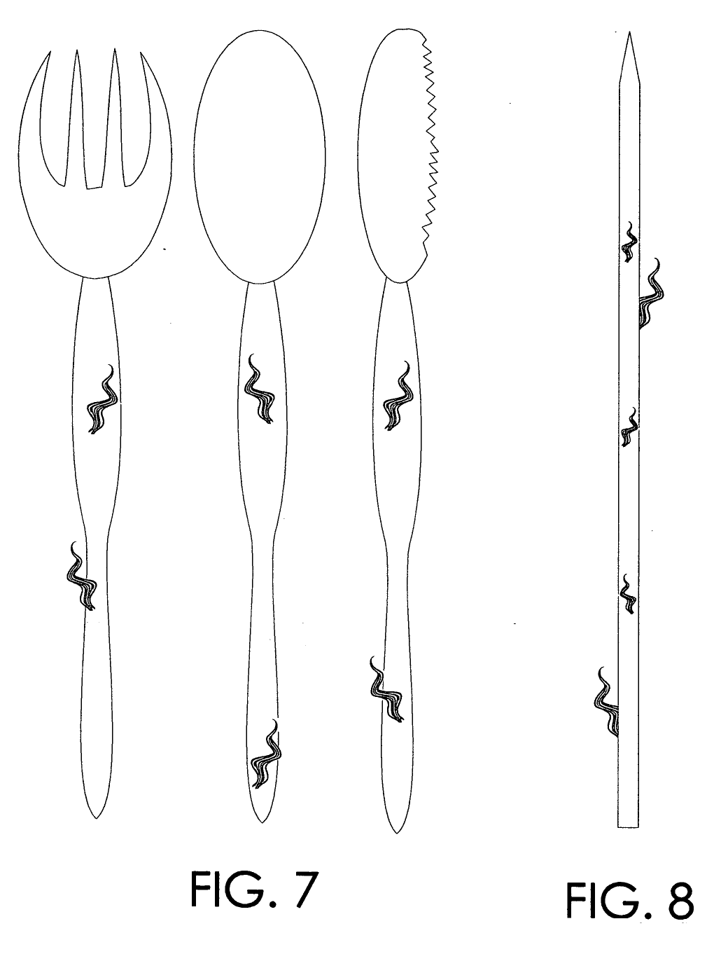

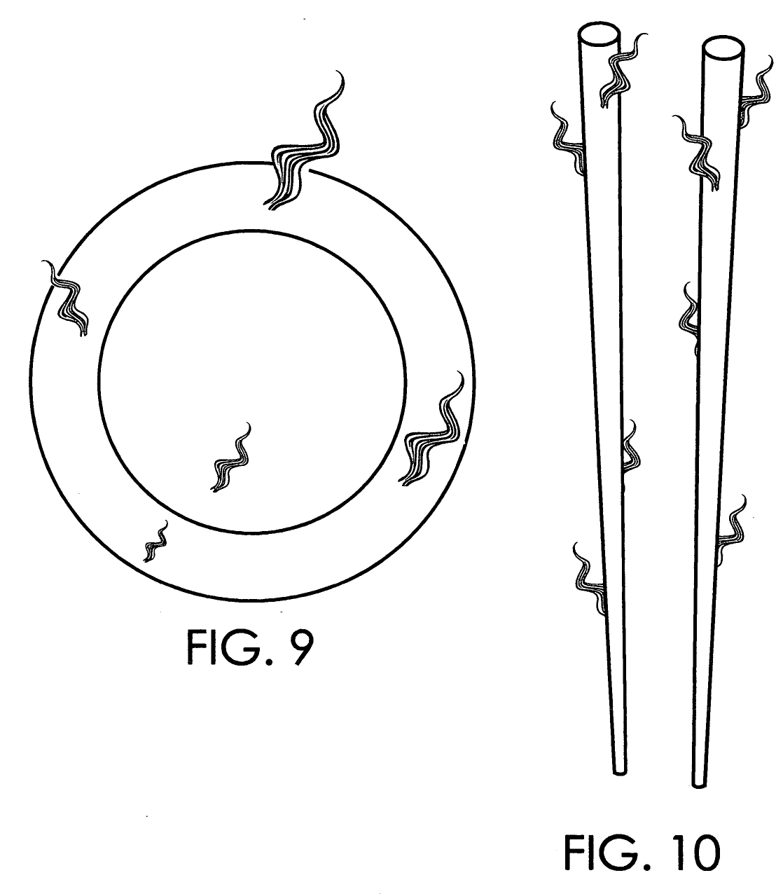

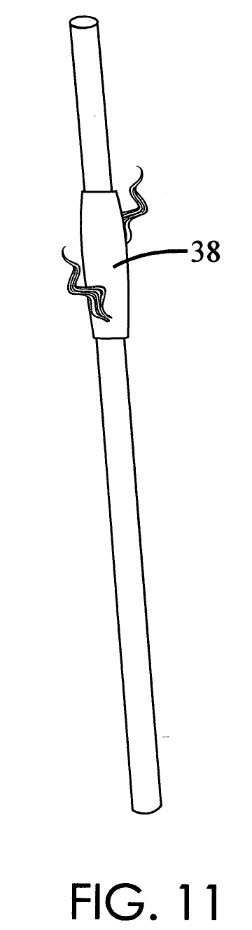

22 Plastic Body
24 Scent
26 First Outlet
28 Second Outlet
30 Vapor Barrier Plastic Packaging
32 Cup Cap
34 Vapor Barrier Plastic Packaging
36 CupBody
38 Add-On Element

### DESCRIPTION OF THE PREFERRED EMBODIMENT

In the preferred embodiment of this disclosed invention, an elongated, circular, tubular body having a First Outlet 26 and a Second Outlet 28 is produced of plastic in a conventional extrusion process. Prior to extrusion using conventional plastic extrusion machinery, conventional pelletized chemical resin containing the essence of at least one essential oil is mixed together with standard plastic pellets. The combination batch is then fed into an extrusion machine at temperatures preferably between 278 degrees Fahrenheit, the flash point for melting conventional plastic, and 300 degrees Fahrenheit. The addition of an essential oil creates Scent 24 which mixes virtually entirely throughout the plastic which will be formed into Plastic Body 22.

As Plastic Body 22 is used, its proximity to the drinker's nose allows the fragrance of Scent 24 to waft into the user's nostrils, thereby enhancing the drinking experience when a typically pleasant fragrant essential oil is used. In the instance in which a “novelty” or “joke” type Plastic Body 22 may be desired, or in a circumstance during which it may be desirable to create a scenario in which the user experiences an unpleasant consuming event, an essential oil having characteristically unpleasing Scent 24 properties may be introduced, thereby negatively influencing a user's consumption.

In an instance in which it may not be desirable to impregnate Plastic Body 22 itself with a scent, Add-On Element 38 may be added to Plastic Body 22 in order to provide Scent 24 in close proximity to a user's nose. Scent 24 may also be added to a coating for the exterior or even the interior of Cup Body 36. Cup Cap 32, which is typically made of plastic, may also be considered a Plastic Body 22 suitable for impregnation with Scent 24 during its molding fabrication process.

Regarding packaging, Plastic Body 22 is inserted into Vapor Barrier Plastic Packaging 30, preferably composed of a plastic polymer material such as EVOHt™ which is extremely resistant to scent dissipation. The two ends of the bag are then sealed using a conventional heat-sealing machine.

This invention is a novel system. While preferred embodiments of the present invention have been described and illustrated using specific terms, such description is for illustrative purposes only. It may be appreciated and understood that many changes and modification of the invention as described herein may be made by a person skilled in the art to which this subject matter pertains without substantially deviating from the spirit and scope of the invention and of the following claims. As the preferred embodiment is capable of variation, addition, omission and modification without departing from the spirit an scope of the invention, consequently, it is not the intention of the applicant to limit his invention to those modes and embodiments of the invention shown or described above. Protection is desired for all changes and modifications that come within the spirit of the invention.

1. A scent delivery system comprising:
at least a tube-like chamber having a first outlet and a second outlet;
wherein a suction applied at, on or about an outlet induces a flow of liquid pulled from a liquid reservoir through said first and second outlet as well as said tube-like chamber;
a scent source means.

2. The scent delivery system of claim 1, wherein:
said at least a tube-like chamber is of a synthetic material;
said scent source means is in removable contact with said tube-like chamber.

3. The scent delivery system of claim 2, wherein:
said at least a tube-like chamber synthetic material is plastic;
said scent source means in removable contact with said at least a tube-like chamber is a body having a first outlet and a second outlet, thereby permitting said at least a tube-like chamber to be inserted therethrough.

4. The scent delivery system of claim 3, wherein:
means for maintaining said scent source means in contact with said at least a tube-like chamber at least an engineered design, whereby the inner diameter of said scent source means is narrower than the outer diameter of said at least a tube-like chamber.

5. The scent delivery system of claim 4, wherein:
said scent source means is in removable contact with said at least a tube-like chamber is an elongated plastic strip impregnated with at least an essential oil;
wherein said elongated strip is attached to said at least a tube-like chamber via at least an engineered design, whereby said elongated plastic strip has attaching-grip means integrally molded thereto.

6. The scent delivery system of claim 2, wherein:
said scent source means in removable contact with said at least a tube-like chamber is an elongated plastic strip impregnated with at least an essential oil including means to attach said elongated strip to said at least a tube-like chamber.

7. The scent delivery system of claim 1, wherein:
said at least a tube-like chamber is of a synthetic material;
said scent source means is an integral combination of at least one essential oil integrally pervading said synthetic material used in the production of said tube-like chamber.

8. The scent delivery system of claim 9, wherein:
said at least a tube-like chamber synthetic material is plastic;
said scent delivery system is enclosed within means to prevent said scent from substantially dissipating until such time that release of said scent is deemed desirable.

9. The scent delivery system of claim 10, wherein:
said means to prevent said scent from substantially dissipating until such time that release of said scent is deemed desirable is enclosure in a synthetic packaging.

10. The scent delivery system of claim 9, wherein:
said synthetic packaging is a vapor-barrier plastic.

11. A scent delivery system comprising:
a cup cap;
a scent source means.

12. The scent delivery system of claim 11, wherein:
said cup cap is of synthetic material;
said scent source means is an integral combination of at least one essential oil integrally pervading said synthetic material used in the production of said cup cap.

13. The scent delivery system of claim 12, wherein:
said scent delivery system is enclosed within means to prevent said scent from substantially dissipating until such time that release of said scent is deemed desirable.

14. The scent delivery system of claim 15, wherein:
means to prevent said scent from substantially dissipating until such time that release of said scent is deemed desirable is enclosure in a synthetic packaging.

15. The scent delivery system of claim 14, wherein:
said synthetic packaging is a vapor-barrier plastic.

16. A scent delivery system comprising:
eating utensils;
a scent source means.

17. The scent delivery system of claim 18, wherein:
said eating utensils are of a synthetic material;
said scent source means is an integral combination of at least one essential oil integrally pervading said synthetic material used in the production of said eating utensils.

18. The scent delivery system of claim 17, wherein:
said synthetic material is plastic;
said scent delivery system is enclosed within means to prevent said scent from substantially dissipating until such time that release of said scent is deemed desirable.

19. The scent delivery system of claim 19, wherein:
means to prevent said scent from substantially dissipating until such time that release of said scent is deemed desirable is enclosure in a synthetic packaging.
